(19) United States
(12) Patent Application Publication
(10) Pub. No.: US 2026/0196896 A1
(43) Pub. Date: Jul. 9, 2026

(54) ROTOR HAVING COOLING CHANNELS, AND ELECTRIC MACHINE HAVING SUCH A ROTOR

(71) Applicant: Schaeffler Technologies AG & Co. KG, Herzogenaurach (DE)

(72) Inventors: Lucas Braun, Oberkirch (DE); Matthias Geiser, Sasbachwalden (DE)

(73) Assignee: Schaeffler Technologies AG & Co. KG, Herzogenaurach (DE)

(21) Appl. No.: 19/132,501

(22) PCT Filed: Nov. 3, 2023
(86) PCT No.: PCT/DE2023/100812

§ 371 Date: May 23, 2025

(30) Foreign Application Priority Data
Nov. 25, 2022 (DE) 102022131184.8

(51) Int. Cl. H02K 1/32; H02K 1/274

(52) U.S. Cl. CPC H02K 1/32; H02K 1/274

(57) ABSTRACT

A rotor of an electric machine for a motor vehicle comprises a rotor body having a plurality of rotor magnets situated in magnet pockets. Each magnet is secured by means of a plastic body that extends in the magnet pockets. A plurality of axial cooling channels have outlet openings situated in the end face of the rotor body, from which a cooling fluid is discharged into the surroundings of the rotor whilst the rotor is in operation. A plastic body protrudes, axially out of the rotor body and interacts with one of the outlet openings such that cooling fluid that exits the outlet opening whilst the rotor is in operation is subjected to an axial force component by a fluid-guiding element of the plastic body.

### CROSS-REFERENCE TO RELATED APPLICATIONS

This application is a U.S. national stage application under 35 U.S.C. § 371 that claims the benefit of priority under 35 U.S.C. § 365 of International Patent Application No. PCT/DE2023/100812, filed on Nov. 3, 2023, designating the United States of America, which in turn claims the benefit of priority under 35 U.S.C. § § 119, 365 of German Patent Application No. 102022131184.8, filed on Nov. 25, 2022, the contents of which are relied upon and incorporated herein by reference in their entirety.

### FIELD OF THE DISCLOSURE

The present disclosure relates to a rotor of an electric machine, in particular for a drive train of a motor vehicle, comprising a rotor body having a plurality of magnet pockets extending axially through the rotor body, in each of which at least one rotor magnet is received, and the rotor magnets are each secured by means of a plastic body that extends in the magnet pockets, the rotor body further comprising a plurality of cooling channels which extend axially through the rotor body and through which a cooling fluid can flow, the cooling channels having an end-face outlet opening in the rotor body, from which the cooling fluid is discharged from the cooling channels into the surroundings of the rotor whilst the rotor is in operation. The disclosure further relates to an electric machine.

### BACKGROUND OF THE DISCLOSURE

Electric motors are increasingly being used to drive motor vehicles to create alternatives to internal combustion engines that require fossil fuels. Significant efforts have already been made to improve the suitability of electric drives for everyday use and also to be able to offer users the driving comfort which they are accustomed to.

A detailed description of an electric drive can be found in an article in the German automotive magazine ATZ, volume 113, 05/2011, pages 360-65 by Erik Schneider, Frank Fickl, Bernd Cebulski and Jens Liebold with the title: Hochintegrativ und Flexibel Elektrische Antriebseinheit für E-Fahrzeuge [Highly Integrative and Flexible Electric Drive Unit for E-Vehicles]. Such drive units are also referred to as e-axles or electrically operable drive trains.

In addition to purely electrically operated drive trains, hybrid drive trains are also known. Such drive trains of a hybrid vehicle usually comprise a combination of an internal combustion engine and an electric motor, and enable, for example in urban areas, a purely electric mode of operation while at the same time permitting both sufficient range and availability, in particular when driving cross-country. In addition, drive can also be provided by the internal combustion engine and the electric motor at the same time in certain operating situations.

In the development of electric machines intended for e-axles and hybrid modules, there is a continuing need to increase their power densities, so the cooling of electric machines required for this is growing in importance. Owing to the necessary cooling performance, hydraulic fluids such as cooling oils have become established in most concepts for the removal of heat from the thermally loaded regions of an electric machine.

For the stators of electric machines, for example, jacket cooling and winding head cooling are known from the prior art for the cooling of electric machines using hydraulic fluids. While jacket cooling transfers the heat generated at the outer surface of the laminated rotor core into a cooling circuit, the heat transfer takes place in the case of winding head cooling immediately at the conductors outside the laminated rotor core in the region of the winding heads into the fluid.

Further improvements are provided by separate cooling channels, which are introduced both in the stator laminated core (see, for example, EP3157138 A1) and in the slot, in addition to the conductors (see, for example, Markus Schiefer: Indirekte Wicklungskühlung von hochausgenutzten permanenterregten Synchronmaschinen mit Zahnspulenwicklung [Indirect Winding Cooling of Highly Utilized Permanently Excited Synchronous Machines with Toothed Coil Winding], dissertation, Karlsruhe Institute of Technology (KIT), 2017).

Concepts are also known in which hydraulic fluid flows directly around the windings in order to increase the power density. Improved cooling with direct contact of the hydraulic fluid and conductor in the slot is already known per se from the prior art. For example, DE102015013018 A1 describes a solution for electric machines with a single-tooth winding, wherein the fluid flows directly around the windings, which are wound around the teeth.

In addition to the cooling of stators, it is also generally known to cool the rotors of electric machines.

### SUMMARY OF THE DISCLOSURE

The object of the disclosure is to realize a rotor which can provide high cooling performance simultaneously at low manufacturing costs. It is also the object of the disclosure to realize an improved electric machine.

This object is achieved by a rotor of an electric machine, in particular for a drive train of a motor vehicle, comprising a rotor body having a plurality of magnet pockets which extend axially through the rotor body and in each of which at least one rotor magnet is received, the rotor magnets each being secured by means of a plastic body that extends in the magnet pockets, the rotor body further comprising a plurality of cooling channels which extend axially through the rotor body and through which a cooling fluid can flow, the cooling channels having an end-face outlet opening in the rotor body, from which the cooling fluid is discharged from the cooling channels into the surroundings of the rotor whilst the rotor is in operation, and at least one plastic body protrudes by way of a fluid-guiding element axially out of the rotor body and thus interacts with one of the outlet openings such that cooling fluid that exits the outlet opening whilst the rotor is in operation is subjected to an axial force component by the fluid-guiding element of the plastic body.

This provides the advantage that the fluid-guiding element can be formed integrally with the plastic body, for example during transfer molding or an injection molding process for securing the stator magnets, whereby the fluid-guiding element can be manufactured particularly cost-effectively.

As a material, plastic has the further advantage that it offers many degrees of geometric freedom in terms of its shaping.

A rotor is the rotating (spinning) part of an electric machine. The rotor comprises a rotor shaft. The rotor shaft can be hollow, which on the one hand results in weight savings and on the other hand allows the supply of lubricant or coolant to the rotor body. The hollow shaft of the contactless energy transmission device is a rotor shaft of a rotor of an electric machine that is hollow at least in sections.

A rotor body within the meaning of the disclosure is understood to mean the rotor without a rotor shaft. The rotor body may be made of a laminated rotor core. Permanent magnets may be inserted into the pockets of the laminated rotor core or secured circumferentially to the laminated rotor core. Further, axial cover parts for closing the pockets may be included, as described further herein.

The rotor may have a plurality of rotor bodies. The rotor bodies may be formed substantially of the same parts and/or substantially identically. The rotor bodies may be formed from identical and/or substantially identical rotor laminations. The rotor bodies may be formed from a laminated rotor core and may be composed of a plurality of laminated individual sheets or rotor laminations, usually made of electrical steel, which are layered and stacked one above the other to form a stack, what is termed the laminated rotor core. The individual sheets can be held together in the laminated rotor core by adhesive bonding, welding or screwing. A laminated rotor core may also have permanent magnets which are inserted into the pockets of the laminated rotor core or which are secured circumferentially to the laminated rotor core. It is possible for the laminated rotor cores to be offset with respect to each other, i.e. be arranged in a manner turned through an angle with respect to one another. This offset can be linear or V-shaped to avoid or at least reduce axial forces. The cooling channels may be designed such that no radial undercut is formed and cooling fluid can flow out axially.

The permanent magnets to be introduced into the pockets of the laminated rotor core may be understood as the rotor magnets. The permanent magnets can be introduced into the pockets of the laminated rotor core. A single larger rotor magnet designed as a bar magnet or a plurality of smaller permanent magnet elements can be provided for each pocket.

A laminated rotor core can form a rotor body. A laminated rotor core is understood to mean a plurality of laminated individual sheets or rotor laminations which are generally made from electrical steel and are layered and stacked one on top of the other to form a stack or what is known as a laminated rotor core. The individual sheets can then remain held together in the laminated core by adhesive bonding, welding or screwing. A laminated rotor core can also have magnetic elements introduced into the pockets of the laminated rotor core or secured circumferentially on the laminated rotor core as well as any axial cover parts for closing the pockets and the suchlike.

The electric machine can be designed as a rotary machine. The rotary machine can be configured as a radial flow machine. The magnetic field lines in the air gap formed between the rotor and stator may extend in a radial direction. The gap between the rotor and the stator is referred to as the air gap. In a radial flow machine, this is an annular gap in cross-section with a radial width that corresponds to the distance between the rotor body and the stator body.

The electric machine may be used within a drive train of a hybrid or fully electrically driven motor vehicle. The electric machine may be dimensioned such that vehicle speeds of more than 50 km/h, more than 80 km/h, and/or more than 100 km/h can be achieved. The electric motor may have an output of more than 50 kW, more than 80 kW, and/or than 150 kW. Furthermore, the electric machine may provide speeds greater than 8000 rpm, greater than 12,000 rpm, and/or greater than 15,000 rpm.

For the purposes of this application, motor vehicles are land vehicles that are moved by machine power without being bound to railroad tracks. A motor vehicle can be selected, for example, from the group of passenger cars, trucks, small motorcycles, light motor vehicles, motorcycles, motor buses/coaches or tractors.

According to an embodiment of the disclosure, the cooling channels may be arranged in the cross-section of the rotor body on a circular path. This may allow for uniform cooling performance to be achieved. The diameter of the circular path may be selected such that the cooling channels extend radially below the rotor magnets. In some embodiments, the center of the circular path runs coaxially with respect to the rotation axis of the rotor.

According to an embodiment of the disclosure, the fluid-guiding element may be arranged radially above the outlet opening assigned to it. Further, the fluid-guiding element may be positioned radially aligned with the outlet opening assigned to it, whereby a particularly short fluid path between the outlet opening and the fluid-guiding element can be realized, which contributes to a particularly good and controlled fluid guidance.

Furthermore, according to an embodiment of the disclosure, a fluid-guiding element may be assigned to all outlet openings on a first end face of the rotor body and/or a fluid-guiding element may be assigned to all outlet openings on a second end face of the rotor body, which contributes to a particularly good cooling effect.

According to an embodiment of the disclosure, two magnet pockets circumferentially adjacent in the cross-section of the rotor body may have a V-shaped arrangement with a radially inwardly pointing tip. Furthermore, the outlet openings may be positioned in the cross-section of the rotor body between two V-shaped arrangements of the magnet pockets. Placing the cooling channel between the poles has the advantage that the space there has the least negative influence on the electric machine with respect to strength and electromagnetism.

Plastic bodies of two circumferentially adjacent V-shaped arrangements may exit axially from the magnet pockets on the first end face of the rotor body and form a substantially W-shaped contour in cross-section, the fluid-guiding element being formed on the radially outwardly pointing tip of the W-shaped contour. This ensures that the function of the electric machine is not negatively affected. Bringing the oil closer to the magnets is also desirable because that is where the thermal hotspot is located and this can further improve cooling.

The fluid-guiding element may be designed as a ramp which has a ramp surface inclined axially away from the rotor body and radially outwards, whereby effective cooling can be realized.

In the case of a plurality of fluid-guiding elements formed on a first end face, it is possible for their ramp surfaces to be formed differently from one another. This ensures that, depending on the rotation speed of the rotor, sufficient cooling of the winding head can be ensured.

The object of the disclosure may be achieved by an electric machine comprising a hollow-cylindrical stator and a rotor rotatably arranged in the stator, a stator winding being received in the stator and exiting axially from the two end faces of the stator to form a winding head in each case.

The disclosure is explained in more detail below with reference to figures without limiting the general concept of the disclosure.

### BRIEF DESCRIPTION OF THE DRAWINGS

In the figures:

FIG. 1 shows a motor vehicle having an electric drive train in a schematic block diagram;

FIG. 2 shows an electric machine in a schematic axial sectional view;

FIG. 3 shows an electric machine in an axial sectional view;

FIG. 4 shows a rotor in a first perspective axial sectional view; and

FIG. 5 shows a rotor in a second perspective axial sectional view.

### DETAILED DESCRIPTION

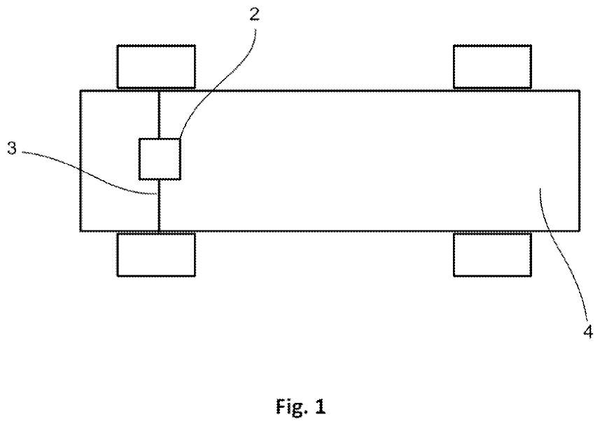

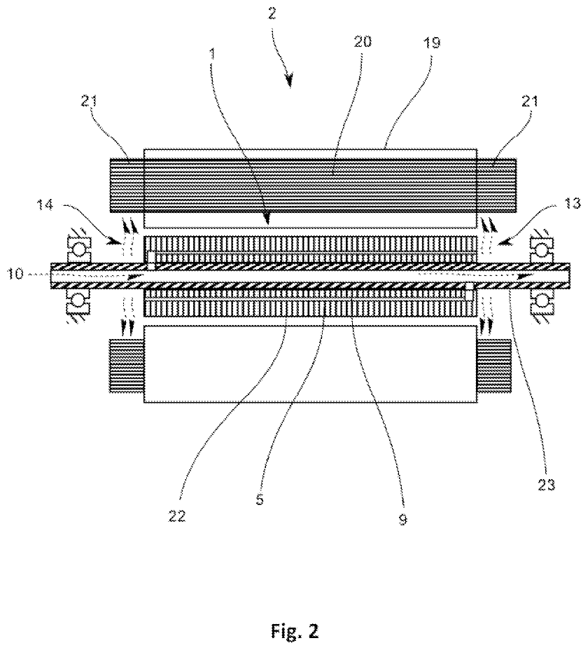

The disclosure can include an electric machine 2 for a drive train 3 of a motor vehicle 4, as shown by way of example in FIG. 1. The electric machine 2 is shown in an axial sectional view in FIG. 2.

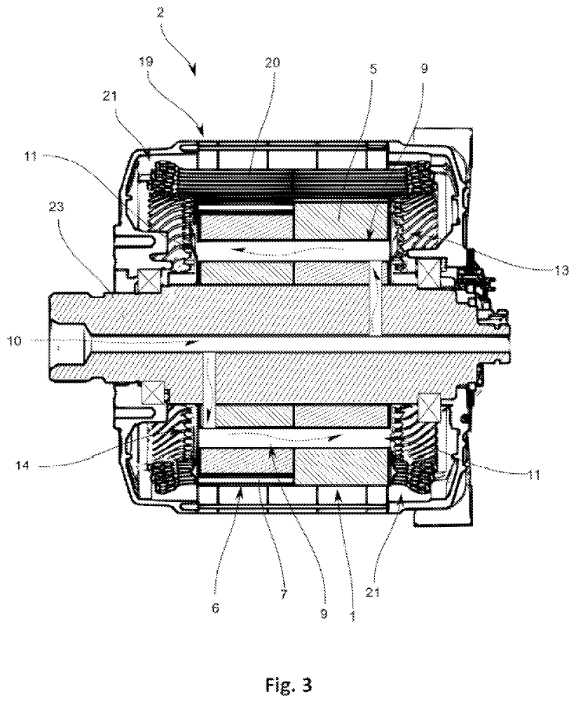

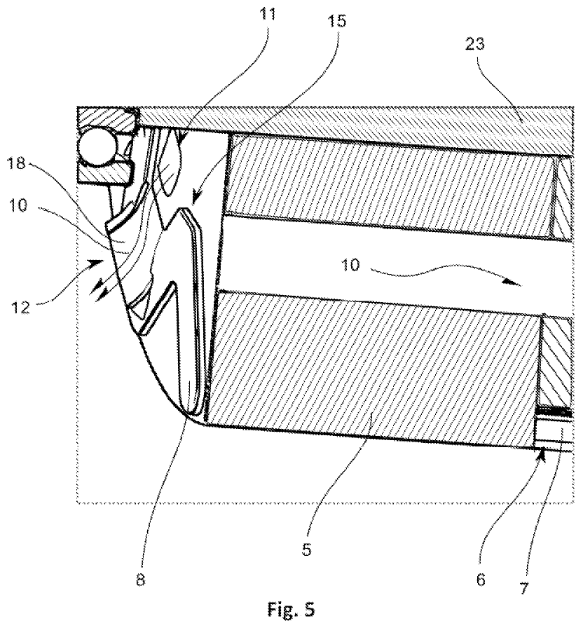

The electric machine 2 comprises a hollow-cylindrical stator 19 and a rotor 1 rotatably arranged in the stator 19, wherein a stator winding 20 is received in the stator 19 and exits axially from the two end faces of the stator 19 to form a winding head 21 in each case. The rotor body 5 of the rotor 1, formed from a plurality of stacked rotor laminations 22, is connected in a rotationally fixed manner to the rotor shaft 23 and has a fluid-guiding element 12 that is configured such that cooling fluid 10 is guided to one of the winding heads 21 whilst the electric machine 2 is in operation. This is explained in more detail on the basis of FIGS. 2-5.

The rotor 1 of the electric machine 2 has a rotor body 5 with a plurality of magnet pockets 6 which extend axially through the rotor body 5 and in each of which at least one rotor magnet 7 is received. The rotor magnets 7 are each secured by at least one plastic body 8 that extends in the magnet pockets 6. The rotor body 5 further includes a plurality of cooling channels 9 which extend axially through the rotor body 5 and through which a cooling fluid 10 can flow. The cooling channels 9 each have an end-face outlet opening 11 in the rotor body 5, from which the cooling fluid 10 is discharged from the cooling channels 9 into the surroundings of the rotor 1 whilst the rotor 1 is in operation.

One plastic body 8 protrudes, by way of a fluid-guiding element 12, axially out of the rotor body 5 and thus interacts with one of the outlet openings 11 such that cooling fluid 10 that exits the outlet opening 11 whilst the rotor 1 is in operation is subjected to an axial force component by the fluid-guiding element 12 of the plastic body 8.

The fluid-guiding element 12 is arranged radially outboard of the outlet opening 11 assigned to it, in some embodiments. In some embodiments, the fluid-guiding element 12 is positioned radially aligned with the outlet opening 11 assigned thereto.

A fluid-guiding element 12 is assigned to all outlet openings 11 on a first end face 13 of the rotor body 5 and a fluid-guiding element 12 is assigned to all outlet openings 11 on a second end face 14 of the rotor body 5.

Two circumferentially adjacent magnet pockets 6 in the cross-section of the rotor body 5 each have a V-shaped arrangement 15 with a radially inwardly pointing tip. The outlet openings 11 are positioned in the cross-section of the rotor body 5 between two V-shaped arrangements 15 of the magnet pockets 6.

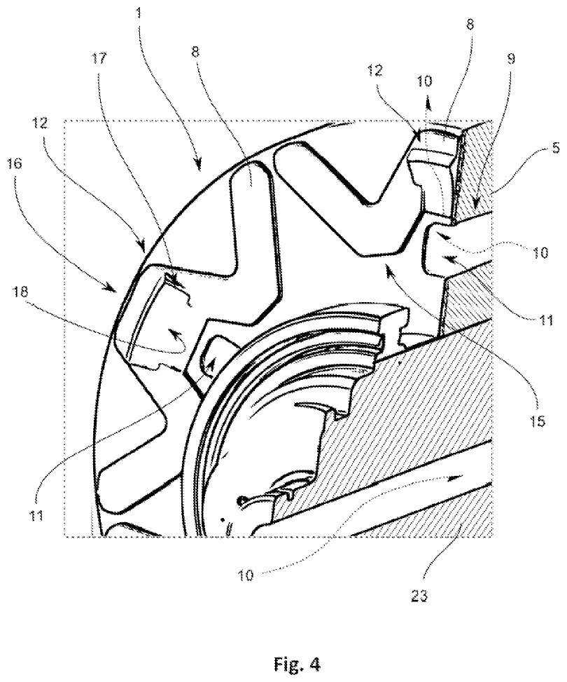

As shown in FIG. 4, the at least one plastic body 8 of two circumferentially adjacent V-shaped arrangements 15 exits axially from the magnet pockets 6 on the first end face 13 of the rotor body 5 and forms a substantially W-shaped contour in cross-section, and the fluid-guiding element 12 is formed on the radially outwardly pointing tip 16 of the W-shaped contour. The fluid-guiding element 12 is designed as a ramp 17 which has a ramp surface 18 inclined axially away from the rotor body 5 and radially outwards. In the case of a plurality of fluid-guiding elements 12 formed on a first end face 13, their ramp surfaces 18 may be designed differently from one another.

The disclosure is not limited to the embodiments shown in the figures. The above description is therefore not to be regarded as limiting, but rather as illustrative. The following claims are to be understood as meaning that a stated feature is present in at least one embodiment of the disclosure. This does not exclude the presence of further features.

### List of Reference Signs

1 Rotor
2 Electric machine
3 Drive train
4 Motor vehicle
5 Rotor body
6 Magnet pocket
7 Rotor magnet
8 Plastic body
9 Cooling channels
10 Liquid cooling fluid
11 Outlet opening
12 Fluid-guiding element
13 End face
14 End face
15 Arrangement
16 Tip
17 Ramp
18 Ramp surface
19 Stator
20 Stator winding
21 Winding head
22 Rotor lamination
23 Rotor shaft

1. A rotor an electric machine of a motor vehicle, comprising:
a rotor body having a plurality of magnet pockets extending axially through the rotor body, in each of which magnet pockets at least one rotor magnet is received, and a plurality of cooling channels that extend axially through the rotor body, each having an end-face outlet opening in the rotor body, the plurality of cooling channels being configured to have cooling fluid flow therethrough and discharge therefrom via the end-face outlet openings into the surroundings of the rotor in operation of the rotor; and
at least one plastic body that extends into at least one of the plurality of magnet pockets to secure at least one rotor magnet therein, wherein the at least one plastic body includes a fluid-guiding element that extends axially away from the rotor body outside of the at least one magnet pocket and is configured to deflect cooling fluid discharged from a corresponding end-face outlet opening axially away from the rotor body in operation of the rotor.

2. The rotor of claim 1, wherein the fluid-guiding element is arranged radially outboard of the corresponding end-face outlet opening.

3. The rotor of claim 1, wherein the fluid-guiding element is radially aligned with the corresponding end-face outlet opening.

4. The rotor of claim 1, wherein the at least one plastic body includes a plurality of fluid-guiding elements that correspond with the plurality of end-face outlet openings, respectively.

5. The rotor of claim 1, wherein two circumferentially adjacent magnet pockets in the cross-section of the rotor body each have a V-shaped arrangement with a radially inwardly pointing tip.

6. The rotor of claim 5, wherein at least one of the end-face outlet openings is positioned circumferentially between the two circumferentially adjacent magnet pockets having the V-shaped arrangements.

7. The rotor of claim 6, wherein the at least one plastic body extends within the two circumferentially adjacent magnet pockets having the V-shaped arrangements and exits axially from the two magnet pockets, wherein the at least one plastic body forms a substantially W-shaped contour in cross-section, and wherein the fluid-guiding element is formed on the radially outwardly pointing tip of the W-shaped contour.

8. The rotor of claim 1, wherein the fluid-guiding element is designed as a ramp which has a ramp surface inclined axially away from the rotor body and radially outwards.

9. (canceled)

10. An electric machine, comprising:
a stator having a stator winding that is received therein and that exits axially from two end faces of the stator to form a winding head in each case; and
a rotor rotatably arranged in the stator, the rotor comprising:
a rotor body having a plurality of magnet pockets extending axially therethrough and a plurality of cooling channels that extend axially therethrough, wherein each of the plurality of cooling channels has an end-face outlet opening in the rotor body and is configured to have cooling fluid flow therethrough and discharge therefrom via the end-face outlet opening into the surroundings of the rotor in operation of the rotor; and
at least one plastic body that extends into at least one of the plurality of magnet pockets to secure at least one rotor magnet therein, wherein the at least one plastic body includes a fluid-guiding element that extends axially away from the rotor body outside of the at least one magnet pocket and is configured to deflect cooling fluid discharged from a corresponding end-face outlet opening axially away from the rotor body to at least one of the winding heads in operation of the electric machine.

11. The electric machine of claim 10, wherein the fluid-guiding element is arranged radially outboard of the corresponding end-face outlet opening.

12. The electric machine of claim 10, wherein the fluid-guiding element is radially aligned with the corresponding end-face outlet opening.

13. The electric machine of claim 10, wherein the at least one plastic body includes a plurality of fluid-guiding elements that correspond with the plurality of end-face outlet openings, respectively.

14. The electric machine of claim 10, wherein two circumferentially adjacent magnet pockets in the cross-section of the rotor body each have a V-shaped arrangement with a radially inwardly pointing tip.

15. The electric machine of claim 14, wherein at least one of the end-face outlet openings is positioned circumferentially between the two circumferentially adjacent magnet pockets having the V-shaped arrangements.

16. The electric machine of claim 15, wherein the at least one plastic body extends within the two circumferentially adjacent magnet pockets having the V-shaped arrangements and exits axially from the two magnet pockets, wherein the at least one plastic body forms a substantially W-shaped contour in cross-section, and wherein the fluid-guiding element is formed on the radially outwardly pointing tip of the W-shaped contour.

17. The electric machine of claim 10, wherein the fluid-guiding element is designed as a ramp which has a ramp surface inclined axially away from the rotor body and radially outwards.

18. A rotor of an electric machine, comprising:
a rotor body that includes a plurality of magnet pockets that extend axially through the rotor body, including a first magnet pocket and a second magnet pocket that is circumferentially adjacent to the first magnet pocket, and a plurality of cooling channels that extend axially through the rotor body, including a first cooling channel that has an outlet opening that is positioned circumferentially between the first and second magnet pockets, wherein the first cooling channel is configured to convey cooling fluid therein that is discharged via the outlet opening of the first cooling channel into the surroundings of the rotor in operation of the electric machine; and
a plastic body having a first portion that extends within the first magnet pocket, a second portion that extends within the second magnet pocket, and a third portion that extends between the first and second portions of the plastic body outside of the first and second magnet pockets, wherein the third portion includes a ramp having a ramp surface that is circumferentially aligned with the outlet opening of the first cooling channel, that is radially-outboard of the outlet opening of the first cooling channel, and that angles radially outboard and axially away from the rotor body, wherein the ramp surface is configured to deflect cooling fluid discharged from the outlet opening of the first cooling channel axially away from the rotor body.

19. The rotor of claim 18, further comprising:
a plurality of plastic bodies, each extending within at least one of the plurality of magnet pockets, and each including a ramp having a ramp surface configured to deflect cooling fluid axially away from the rotor body.

20. The rotor of claim 19, wherein each of the ramp surfaces is shaped differently than each other ramp surface.
